(19) United States
(12) Patent Application Publication
(10) Pub. No.: US 2025/0377861 A1
(43) Pub. Date: Dec. 11, 2025

(54) ENERGY-EFFICIENT PRE-ENCODED BOOTH FOR STATIONARY WEIGHTS AND ACTIVATIONS

(71) Applicant: Intel Corporation, Santa Clara, CA (US)

(72) Inventors: Amit Agarwal, Hillsboro, OR (US); Steven Hsu, Lake Oswego, OR (US); Mark A. Anders, Hillsboro, OR (US); Deepak Abraham Mathaikutty, Chandler, AZ (US); Arnab Raha, San Jose, CA (US); Ram K. Krishnamurthy, Portland, OR (US)

(73) Assignee: Intel Corporation, Santa Clara, CA (US)

(21) Appl. No.: 19/311,769

(22) Filed: Aug. 27, 2025

Related U.S. Application Data
(60) Provisional application No. 63/782,282, filed on Apr. 2, 2025.

(51) Int. Cl. G06F 7/544

(52) U.S. Cl. CPC G06F 7/5443

(57) ABSTRACT

A neural network accelerator can perform energy-efficient multiply-and-accumulate operations of a neural network by Booth encoding a stationary operand, such as weights, before a compute phase. The Booth-encoding circuitry generates and stores Booth encoded multipliers in a Booth encoded multiplier storage and a precomputed compensation value representing a sum of the compensation bits of the Booth encoded multipliers in a Booth compensation storage. Per-cycle Booth encoding and compute of the sum of the compensation bits are avoided during multiply-accumulate operations because Booth encoding is applied to stationary operands. The Booth encoder can be located at the periphery where the multiplicands are loaded onto the accelerator shared across multiple compute columns and/or tiles to amortize the Booth encoder area overhead. The Booth encoder supports reconfigurable operand bit widths (e.g., 16-, 8-, 4-, and 2-bit). The approach is applicable to single-instruction-multiple data (SIMD) arrays, systolic arrays, and analog/digital compute-in-memory arrays.

### CROSS-REFERENCE TO RELATED APPLICATION

This application claims priority to and/or receives benefit from U.S. Provisional Application No. 63/782,282, filed on 2 Apr. 2025 and titled “ENERGY-EFFICIENT PRE-ENCODED BOOTH FOR STATIONARY WEIGHTS AND ACTIVATIONS”. The US Provisional Application is hereby incorporated by reference in its entirety.

This application is related to International Patent Application No. PCT/US2025/035021, filed on 24 Jun. 2025 and titled “ENERGY-EFFICIENT DIGITAL COMPUTE-IN-MEMORY”. The International Application is hereby incorporated by reference in its entirety.

### BACKGROUND

Deep neural networks (DNNs) are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1A illustrates a single-instruction-multiple-data (SIMD) array architecture, according to some embodiments of the disclosure.

FIG. 1B illustrates a systolic array architecture, according to some embodiments of the disclosure.

FIG. 1C illustrates a compute-in-memory (CiM) architecture, according to some embodiments of the disclosure.

FIG. 2 compares array multiplication versus Radix-4 Booth multiplication, according to some embodiments of the disclosure.

FIG. 3 illustrates a Radix-4 Booth multiplier with a Booth encoder, according to some embodiments of the disclosure.

FIG. 4 illustrates Radix-4 Booth encoding, according to some embodiments of the disclosure.

FIG. 5 illustrates implementing Booth encoded weights with a shared Booth encoder in a SIMD array architecture.

FIG. 6 illustrates implementing Booth encoded weights with a shared Booth encoder in a systolic array architecture, according to some embodiments of the disclosure.

FIG. 7 illustrates implementing Booth encoded weights with a shared Booth encoder in a CiM architecture, according to some embodiments of the disclosure.

FIG. 8 illustrates Booth compensation circuitry, according to some embodiments of the disclosure.

FIG. 9 illustrates 12b Booth encoded weights, according to some embodiments of the disclosure.

FIG. 10 illustrates a reconfigurable Booth encoder operating as a one 8b weights Booth encoder or a two 4b weights Booth encoder, according to some embodiments of the disclosure.

FIG. 11 illustrates a digital CIM (DCiM) implementation with a Booth encoder on activations, according to some embodiments of the disclosure.

FIG. 12 illustrates a DCiM implementation with a Booth encoder on stationary weights, according to some embodiments of the disclosure.

FIG. 13 illustrates zero-point quantization, according to some embodiments of the disclosure.

FIG. 14 illustrates integrating of the DCiM implementation as part of a neural processing unit, according to some embodiments of the disclosure.

FIG. 15 is a flow diagram illustrating a method for accelerating multiply-and-accumulate operations of a neural network, according to some embodiments of the disclosure.

FIG. 16 is a block diagram of an exemplary computing device, according to some embodiments of the disclosure.

### DETAILED DESCRIPTION

### Overview

Whether it is cloud or edge devices, Artificial Intelligence (AI), Machine Learning (ML) and DNNs play a role for a host of applications in the domains of computer vision, speech recognition, large language models (LLMs), image, and video processing, due to their ability to achieve superhuman-level accuracy. AI edge devices like AI personal computers (AI PCs) are becoming more vital due to the importance of privacy, low latency, and network bandwidth.

Current hardware architectures like Central Processing Units (CPUs), and Graphics Processing Units (GPUs) rely on data reuse from the local memory with restructured algorithms based on known access patterns. However, in traditional computing architectures, e.g. CPUs, GPUs, and Field Programmable Gate Arrays (FPGAs), most of the energy is consumed by memory accesses due to data data-centric nature of ML computing and hence they may struggle to meet the future needs of energy-constrained AI edge applications.

Designing DNN-based ML accelerators for improved energy efficiency has been a rapidly emerging field. Different processing architectures (e.g., SIMD array, systolic array, CiM, etc.) for ML computation and stationary dataflows (e.g., input stationary, weight stationary, and output stationary, etc.) to exploit data reuse have been explored trading-off flexibility, efficiency, and scalability.

Multiply-and-accumulate (MAC) operations are common in DNNs, and executing MAC operations on ML accelerators can consume significant compute power. A MAC operation, or a dot product operation, involves performing element-wise multiplication of multipliers and multiplicands and summing the products of the element-wise multiplications. Booth encoding can be used to reduce the number of partial products generated during multiplication, thereby enhancing energy efficiency and hardware utilization. However, the overhead of Booth encoding can in some cases outweigh the benefits. Some DNN accelerators either use array multiplier or do Booth encoding at the multiplier itself without considering input stationarity, resulting in Booth encoding power/area overhead.

A DNN accelerator (sometimes referred to as neural network hardware accelerators, digital accelerators, or neural processing units (NPUs)) dataflow has a property where one of the inputs (activations or weights) is stationary for multiple compute cycles, while the second input changes every cycle. Leveraging this activation/weight stationary property in the dataflow, Booth encoding can be performed on stationary inputs, which can eliminate the Booth encoding power during compute. Integrating Booth encoding on stationary inputs into a DNN accelerator is not trivial, as various design considerations are to be taken into account to ensure that Booth encoding power/area overhead is minimized.

To integrate Booth encoding in a power efficient manner, an accelerator can perform energy-efficient multiply-and-accumulate operations of a neural network by Booth encoding a stationary operand, such as weights, before a compute phase. The accelerator exploits stationary operand (e.g., weight stationary) dataflows to move Booth encoding out of the compute loop. Booth encoding can be performed once on stationary multipliers and the generated Booth encoded multipliers can be stored in local Booth encoded multiplier storage. Booth encoded multipliers are stored rather than the original multipliers, and the compute cycles thus operate without having to perform Booth encoding. The Booth encoded multipliers can be used by the multiplication circuits many times, over and over again, for the compute cycles while the multiplicands are switching during the compute cycles. Per-cycle Booth encoding is avoided during many compute cycles of the multiply-and-accumulate operations because Booth encoding is applied on the stationary operands that are not changing across the compute cycles.

Recognizing that a Booth compensation bit depends on or is directly derived from the Booth encoded multipliers and the summing of the Booth compensation bits across the channels (e.g., across the multipliers or across the rows) can be performed independently from the accumulation operation of the products, the summing of the Booth compensation bits can be performed ahead of time and just once by a Booth compensation circuitry. The sum of the Booth compensation bits, referred to as a compensation value, can be distributed to a Booth compensation storage, and the accumulation circuitry can apply the stored compensation value to an accumulation output without recomputing sign corrections. This approach to pre-calculate the compensation value avoids redundant accumulation calculations and avoids per-cycle calculation of the compensation value. The summing of the Booth compensation bits can be efficiently implemented in hardware using a tree adder in the Booth compensation circuitry.

To reduce the area overhead, Booth encoding can be performed at the boundary or periphery of the DNN accelerator, where stationary inputs, e.g., the stationary multiplicands, are being supplied or loaded onto the DNN accelerator. Moreover, the Booth encoding circuitry can be time-shared across multiple compute columns and/or tiles during multiple write cycles or over many successive cycles. This implementation shares and amortizes the area and power of Booth encoding circuits across multiple stationary input writes.

A reconfigurable Booth encoding technique can be implemented to avoid having to implement multiple Booth encoders to support different multiplicand bit widths. The technique can enable variable bit width reconfigurable stationary input computes, e.g., 16b, 8b, 4b, 2b, etc. Herein, “Xb” denotes “X-bit” or “X bits”, where X is the number of bits. In particular, the Booth encoder can support reconfigurable operand bit widths (e.g., 16-, 8-, 4-, and 2-bit). In some implementations, a Booth encoder can be reconfigured to process two X-bit multiplicands and produce two Booth encoded multiplicands respectively, or to process one 2*X-bit multiplicands and produce one Booth encoded multiplicand.

The approach has wide applicability to different fabrics and compute architectures performing MAC operations, such as SIMD arrays, systolic arrays, and analog/digital compute-in-memory arrays.

The approach can interoperate with zero-point quantization (e.g., 8-bit values shifted to signed 9-bit values) prior to Booth encoding.

The result is an implementation that can achieve significant improvements in energy efficiency over some other implementations by minimizing switching activity in the accelerator while only incurring modest storage overhead of Booth encoded multipliers.

The improved implementation of the DNN accelerator can have applications in computer vision, speech recognition, and large language models, where AI is delivering unprecedented levels of accuracy and performance. The DNN accelerator can be used in AI inference devices, such as AI-enabled PCs, and for AI training in GPUs and servers.

The integrated circuit can be beneficial for data flows where the multiplicands are stationary. For instance, the multipliers may correspond to input activations of a neural network and the multiplicands can correspond to weights of the neural network to perform weight stationary operations (where the same set of weights are being multiplied with many different input activations). In another instance, the multipliers may correspond to weights of a neural network and the multiplicands can correspond to input activations of the neural network to perform activation stationary operations (where the same set of input activations are being multiplied with many different weights).

While many examples illustrate a particular implementation for handling values having a certain bit width, it is envisioned that the teachings are applicable to handle values having other bit widths. While many examples illustrate having a certain number of channels and columns, it is envisioned that the teachings can be applied to other designs handling a different number of channels and/or columns. While many examples illustrate a particular version of Booth encoding that operates on groups of three multiplier bits, it is envisioned that the teachings can be applied in architectures where another version of Booth encoding is implemented. While many examples illustrate multiplicands corresponding to weights and multipliers corresponding to input activations, it is envisioned that the teachings can be applied to multiplicands corresponding to input activations and multipliers corresponding to weights.

### Architectures Used in DNN Accelerators

FIGS. 1A-C illustrate architectures for computing vector-matrix-multiplication (VMM) and matrix-matrix-multiplication (MMM). These architectures and their variations can be used in DNN accelerators.

SIMD architecture of FIG. 1A comprises an array of parallel processing elements (PEs) to compute the dot product between two vectors (e.g., activation vector and weight vector). A PE receives a pair of data from input (activation and weights) register files/memories and writes the results back to the output register file/memory to accumulate over later. SIMD architecture provides flexibility and programmability to support diverse workloads. To reduce data movement power, the SIMD architecture can keep either weight or activation inputs to be stationary at the PE's registers for many cycles.

A systolic array of FIG. 1B comprises a 2-dimensional array of PEs, where a PE is connected to its immediate neighbors. The activation inputs are sent from one side of the array while weights are cached in PEs. A PE performs a multiplication between incoming inputs from the left and the cached weights, followed by adding the products to the incoming partial sum from the top. The inputs are sent horizontally to the next PE while partial sums are passed vertically down to the next PE. Finally, the outputs are sent from bottom side of the array. The systolic array demands lower data bandwidth due to efficient weight reuse while restricting the inputs and partial sum movements to neighboring PEs. The activation and the weight inputs can be interchanged to enable weight or activation stationary dataflow.

A CiM architecture of FIG. 1C comprises an in-memory weight storage in multiple columns. A column also includes a compute unit which performs bit/nibble/byte serial multiplication between stored weights and broadcasted activation inputs, finally sending the accumulated output to the bottom of the array. The CiM architecture results in higher compute density and energy efficiency due to in-memory weight storage and wide-input broadcast to each column with serial inner product. Again, the activation and the weight inputs can be interchanged to enable weight or activation stationary dataflow. The CiM architecture can include an analog CiM implementation, where the multiplication and accumulation operations are performed in the analog domain using analog circuitry. The CiM architecture can include a digital CiM implementation, where the multiplication and accumulation operations are performed in the digital domain using digital circuitry.

DNN accelerator design with any of the architectures illustrated in FIGS. 1A-C, involves multipliers. These multipliers can be designed using Radix-4 Booth multipliers to reduce hardware cost and to improve energy efficiency in such designs, as seen in FIG. 2.

### Understanding Radix-4 Booth multiplication

FIG. 2 compares array multiplication versus Radix-4 Booth multiplication, according to some embodiments of the disclosure. Illustration 210, illustration 220, and illustration 230 show the generation of partial products through different multiplication techniques.

For regular 8b×8b array multiplier, each bit of the multiplier is multiplied with the multiplicand, and eight partial products are generated, as seen in illustration 210. The partial products are then aligned and summed using an adder tree to compute the final result. A hardware implementation would include eight multipliers and an adder tree that can sum up eight partial products.

Radix-4 Booth multiplication optimizes the generation of partial products by encoding the multiplier in groups of three multiplier bits (referred to herein as a Booth group), effectively reducing the number of partial products by nearly half compared to regular array multiplication. In operation, each group of three multiplier bits is Booth encoded into a Booth encoded multiplier (also referred to as Booth encoded select signals), which indicates how to make use of the multiplicand to produce a Booth partial product.

In Radix-4 Booth multiplication, a 4-bit multiplier results in three groups of multiplier bits or three Booth groups, which are individually encoded into three corresponding Booth encoded multipliers. A Booth encoded multiplier, or Booth encoded select signals can include three bits (e.g., {single, neg, pos}) to specify how to produce a Booth partial product using the multiplicand. A Booth encoded multiplier or the Booth encoded select signals are fed into a Booth selector, which includes logic circuits to produce a Booth partial product based on the multiplicand according to the Booth encoded multiplier or the Booth encoded select signals. The Booth partial product to be generated according to the group of three multiplier bits based on the multiplicand is depicted in table 202. Three different non-aligned Booth partial products can be aligned and summed to produce the final product of the multiplier and the multiplicand.

For Radix-4 8b×8b unsigned multiplier, five Booth partial products are generated using five groups of three multiplier bits or five Booth groups, as seen in illustration 220. The five Booth partial products are then aligned and summed using an adder tree to compute the final result. A hardware implementation would include five multiplier circuits to produce the Booth partial products based on the multiplicand and an adder tree that can sum up five Booth partial products.

For Radix-4 8b×8b signed multiplier, four Booth partial products are generated using four groups of three multiplier bits or four Booth groups. The four Booth partial products are then aligned and summed using an adder tree to compute the final result. A hardware implementation would include four multiplier circuits to produce the Booth partial products based on the multiplicand and an adder tree that can sum up four Booth partial products.

For Radix-4 Booth multiplications, the number of partial products to generate is cut by half (e.g., from 8 to 4 or 5, as seen in FIG. 2). Also, the circuits/logic to produce the Booth partial products can be simple to implement or synthesize because they merely involve simple manipulation of the multiplicand. Moreover, the adder tree to add the Booth partial products can be smaller since fewer partial products are to be added together. Therefore, Booth multiplication presents a promising alternative to performing array multiplication.

Radix-4 Booth multipliers can reduce the number of partial products by almost half at the cost of adding a Booth encoder to one of the multiplier inputs, as seen in FIG. 3. The Booth encoder cost can be a substantial part of the total area and energy of Radix-4 Booth multiplier.

FIG. 3 illustrates a Radix-4 Booth multiplier with Booth encoder 302, according to some embodiments of the disclosure. FIG. 4 illustrates Radix-4 Booth encoding logic performed by Booth encoder 302, according to some embodiments of the disclosure.

Booth encoder 302 may receive an 8-bit signed multiplier. For an 8-bit signed multiplier, four groups of three multiplier bits of four Booth groups can be used to produce four corresponding Booth encoded multipliers or Booth encoded select signals. Booth encoder 302 has one or more Booth encoder circuits (e.g., four Booth encoder circuits, each receiving a group of three multiplier bits or a Booth group) to produce four Booth encoded multipliers or four sets of Booth encoded select signals (e.g., seen as {single, neg, pos}) for the four Booth groups. The logic implemented by Booth encoder 302 is illustrated in table 402 of FIG. 4.

For a 4b unsigned multiplier, there would be three groups of three multiplier bits. For a 4b signed multiplier there would be two groups of three multiplier bits. For an 8b unsigned multiplier, there would be five groups of three multiplier bits. For an 8b signed multiplier, there would be four groups of three multiplier bits.

A component that can generate the Booth partial product based on the multiplicand and according to the Booth encoded multiplier (e.g., neg, pos, and sing) is referred to herein as a Booth selector. In FIG. 3, Booth selector 304 produces a Booth partial product based on the group of three multiplier bits or the Booth encoded select signals and the multiplicand. The logic implemented by Booth selector 304 to generate partial products is illustrated in table 402 of FIG. 4.

In the illustration in FIG. 3, four Booth partial products are generated by four instances of Booth selector 304 using four corresponding groups of three multiplier bits or four corresponding sets of Booth encoded select signals. The four Booth partial products are then aligned and summed using an adder tree to compute the final result. A hardware implementation would include four multiplier circuits (in the form of Booth selector 304) to produce the Booth partial products based on the multiplicand and an adder tree that can sum up four Booth partial products.

As discussed herein, a DNN accelerator dataflow has a property where one of the inputs (activation or weight) is stationary for multiple cycles, while the second input changes every cycle. The cost of the Booth encoder can be eliminated by leveraging the stationary input property in the design. While various embodiments are described for weight stationary dataflow, the embodiments are applicable to activation stationary dataflow as well.

### Leveraging Data Stationarity: Booth Encoding Stationary Inputs

In weight stationary dataflow, the weights can be written in multiple cycles to (i) weight storage or memory in SIMD array, (ii) weight storage or cache in systolic PE array, or (iii) weight storage or memory cells in compute-in-memory architectures. The number of cycles taken to complete the weight writes can depend on the weight array size and the external bandwidth of the weight inputs. After the weights are written, computes are performed for a plurality of compute cycles, where activation inputs change every cycle while weights remain stationary. Some techniques, e.g., double buffered, can be implemented to hide the weight update while computes are performed to prevent stalls.

In some embodiments, an integrated circuit for a DNN accelerator can be implemented to accelerate MAC operations of a neural network. The integrated circuit can include a Booth encoder (e.g., Booth encoder 302 in the FIGS.). The Booth encoder can receive one or more multipliers, and output one or more Booth encoded multipliers based on the one or more multipliers. The Booth encoder can encode the multipliers using Booth encoding, and output Booth encoded multipliers.

The integrated circuit further includes a Booth encoded multiplier storage to store the one or more Booth encoded multipliers generated by the Booth encoder. Booth encoded multiplier storage represents local storage for the compute circuits of the integrated circuit.

The integrated circuit further includes one or more multiplying circuits to execute a plurality of compute cycles. The multiplying circuits can multiply multipliers and multiplicands and produce products. In one compute cycle of the plurality of compute cycles, the one or more multiplying circuits can multiply the one or more Booth encoded multipliers and the one or more multiplicands and output one or more products.

In some embodiments, a multiplying circuit to multiply a multiplier and a multiplicand can include one or more Booth selectors such as Booth selector 304 of FIG. 3 to produce one or more Booth partial products based on one or more Booth encoded multipliers and a multiplicand. A multiplying circuit can further include alignment circuitry and an adder tree to sum the Booth partial products to produce a product of the multiplier and the multiplicand.

Leveraging the data stationarity, the one or more multipliers that are Booth encoded are stationary for the plurality of compute cycles. The one or more multiplicands are changing or switching for the plurality of compute cycles.

The integrated circuit further includes an adder to add the one or more products produced or generated by the one or more multiplying circuits. The adder may perform the accumulation or summation operation of a MAC operation. The adder may include a tree adder.

Leveraging the weight stationary data flow, the one or more multipliers are one or more weights of the neural network, and the one or more multiplicands are activations of a neural network. Based on this weight stationary property of the dataflow, Booth encoding can be performed on weight inputs to the integrated circuit to eliminate the Booth encoding power during compute.

To reduce the area overhead, Booth encoding can be performed at the boundary of the DNN accelerator, where weight inputs are being supplied. The weight inputs are first Booth encoded in the periphery. The Booth encoder is located in a periphery of the integrated circuit where the one or more multipliers are loaded onto the integrated circuit from a memory external to the integrated circuit.

Booth encoded weights instead of actual weights are written into weight storage (e.g., weight memory, weight cache, or weight memory cells) as illustrated in FIGS. 5-7.

In some embodiments, the Booth encoder is time-wise shared across multiple compute columns or compute tiles to reduce Booth encoder area overhead. Phrased differently, the same Booth encoder can be used to perform Booth encoding and writes Booth encoded multipliers to a plurality of compute columns or compute tiles over a plurality of write cycles. Double buffering in the weight storage can allow for Booth encoded multipliers to be written over a plurality of write cycles as the compute columns or compute tiles are performing compute cycles. In other words, the generation and writing of Booth encoded multipliers can be pipelined.

In some embodiments, the Booth encoder outputs the one or more Booth encoded multipliers during a write cycle; and the Booth encoder outputs the one or more further Booth encoded multipliers during a further write cycle. The Booth encoder is reused for multiple compute columns or compute tiles. The integrated circuit can further include one or more further multiplying circuits to execute a plurality of further compute cycles. A further compute cycle of the plurality of further compute cycles includes the one or more further multiplying circuits multiplying the one or more further Booth encoded multipliers and one or more further multiplicands and outputting one or more further products. The one or more further multipliers are stationary for the plurality of further compute cycles. The one or more further multiplicands are switching or changing for the plurality of further compute cycles.

FIG. 5 illustrates implementing Booth encoded weights with a shared Booth encoder in a SIMD array architecture. The shared Booth encoder is shown as Booth encoder 302. The SIMD architecture of FIG. 5 comprises array 530 having parallel PEs to compute the dot product between two vectors (e.g., activation vector and weight vector). Activations in the activation vector are written to activation memory 506 (e.g., local storage, register file, local memory). Booth encoder 302 receives weights in the weight vector and performs Booth encoding on the weights and produce Booth encoded weights. The Booth encoded weights produced by Booth encoder 302 are written to Booth encoded weight memory 516 (e.g., local storage, register file, local memory). A PE in array 530 receives an activation as a multiplicand and one or more Booth encoded weights as a multiplier and performs multiplication of the multiplicand and the multiplier and generate a product of the multiplicand and the multiplier. For example, the PE can produce Booth partial products based on the activation and the Booth encoded weights, align the Booth partial products, and sum the Booth partial products to form the product. The PE writes the product to output memory 508 (register file or local memory) to accumulate over later. SIMD architecture provides flexibility and programmability to support diverse workloads.

FIG. 6 illustrates implementing Booth encoded weights with a shared Booth encoder in a systolic array architecture, according to some embodiments of the disclosure. The shared Booth encoder is shown as Booth encoder 302. Systolic array 630 of FIG. 6 comprises a 2-dimensional array or grid of PEs, where a PE is connected to its immediate neighbors. Activations in the activation matrix are written to activation memory 506 (e.g., local storage, register file, local memory). Booth encoder 302 receives weights in the weight matrix and performs Booth encoding on the weights and produce Booth encoded weights. The Booth encoded weights produced by Booth encoder 302 are written to Booth encoded weight memory 516 (e.g., local storage, register file, local memory). Systolic array 630 can be configured to rhythmically compute and pass data through systolic array 630 in a synchronized manner, much like the pulsing of a heart (hence “systolic”). Each PE performs MAC operations and communicates only with its neighbors. Input data (e.g., rows of activations and columns of Booth encoded weights) flows into the array from different directions. As the input data moves through systolic array 630, each PE computes partial results and passes them along. This parallel and pipelined architecture enables high-throughput and efficient computation, especially suited for tasks in signal processing and machine learning. As shown, the activation inputs are sent to the left side of systolic array 630 from activation memory 506. Booth encoded weights are sent to the top side of systolic array 630 from Booth weight memory 516, and the Booth encoded weights are cached in the PEs. A PE performs multiplication between incoming inputs from the left and the cached Booth encoded weights from the top, followed by adding the products to the incoming partial sum from the top. The inputs are sent horizontally to the next PE while partial sums are passed vertically down to the next PE. Finally, the outputs are sent from bottom side of systolic array 630 to output memory 508. Systolic array 630 demands lower data bandwidth due to efficient Booth encoded weight reuse while restricting the inputs and partial sum movements to neighboring PEs.

FIG. 7 illustrates implementing Booth encoded weights with a shared Booth encoder in a CiM architecture, according to some embodiments of the disclosure. The shared Booth encoder is shown as Booth encoder 302. CiM array 730 of FIG. 7 has CiM columns. The depicted CiM array 730 has four CiM columns and a plurality of rows of CiM cells within each CiM column. A CiM cell has memory storage and compute circuitry integrated with the memory storage. Activations in the activation matrix are written to activation memory 506 (e.g., local storage, register file, local memory). Booth encoder 302 receives weights in the weight matrix and performs Booth encoding on the weights and produce Booth encoded weights. The Booth encoded weights produced by Booth encoder 302 are written to Booth encoded weight memory, e.g., Booth weight memory 516 of a CiM column in CiM array 730, or in-memory weight storage of the CiM cells in CiM array 730. Memory storage of a CiM cell may include memory bit cells to store Booth encoded weights. Compute circuitry of a CiM cell can include circuitry to perform Booth multiplication between stored Booth encoded weight and activation input, e.g., generate Booth partial products, align the Booth partial products, and sum the Booth partial products, to produce a product. A CiM column of CiM array 730 can produce a plurality of products. Compute circuitry of a CiM column, e.g., compute 716 of a CiM column in CiM array 730, can include adder circuitry to add, accumulate, or sum the products produced in the CiM column to perform accumulation. The compute circuitry of the CiM column can send the accumulated output towards the bottom of the array to be stored in output memory 508.

The activation and the Booth encoded weight inputs can be interchanged in FIGS. 5-7 to enable weight or activation stationary dataflow.

Storing the Booth encoded weights instead of weights themselves may demand an increase in the weight storage area, as illustrated in FIG. 9. FIG. 9 illustrates Booth encoder 302 generating 12b Booth encoded weights based on the original 8b weights. This means that using and storing Booth encoded weights demands more storage area and capacity in Booth weight memory 516 seen in FIGS. 5-7 when compared to using and storing original weights. However, this storage area/write power associated with using Booth encoded weights is a much smaller percentage of the total DNN accelerator area/power, which is dominated by compute.

### Precomputing Booth Compensation Value

Booth compensation bits, “S-Bit” as seen in table 402 of FIG. 4, can be derived from Booth encoded multipliers or the set of Booth encoded select signals. The S-bit, sometimes referred to as the sign bit, can indicate whether the Booth partial product is to be added or subtracted, or whether to add or subtract a correction term. The Booth compensation bit is the negated version of the “pos” select signal and can be used for sign extension and rounding.

The accumulation operation in a MAC operation performs adding or summing across channels (or a column). In one example, the summing across channels can occur at the level of Booth partial products, where Booth partial products across the channels for individual Booth groups are summed together respectively, and summed Booth partial products for the different Booth groups are aligned and summed again to form the final accumulated output. In another example, the summing across channels can occur at the level of products generated after the Booth partial products are combined, where products across the channels are summed together to form the final accumulated output of a MAC operation.

Recognizing that the Booth compensation bits do not depend on the multiplicand, and the accumulation operation on the Booth compensation bits across the channels can be performed independently from the accumulation operation at the level of Booth partial products and/or the products generated after the Booth partial products are combined, the summing or accumulation of the Booth compensation bits can thus be performed ahead of time to produce a compensation value using Booth compensation circuitry, and the compensation value can be stored in Booth compensation storage. The compensation value can be applied or added later in the accumulation operation as a constant so long as the Booth encoded weights are stationary and avoids the need for repeated calculations for the compensation value. This pre-calculation streamlines processing and saves computing resources, with hardware implementation via a tree adder in the Booth compensation circuitry.

The S-bit corresponding to a Booth encoded multiplier or a set of Booth select signals can cause a correction term to be applied during accumulation of Booth partial products. Instead of storing the S-bits and applying the correction term during accumulation of Booth partial products or products generated after the Booth partial products are combined, all the contributions of S-bits across the channels are accumulated and pre-calculated as a compensation value. The compensation value can then be applied and reused in the accumulation Booth partial products or products generated after the Booth partial products are combined, as long as the Booth encoded multipliers remain stationary.

Referring back to FIGS. 5-7, Booth compensation circuitry 504 can be added to receive or determine one or more Booth compensation bits from the one or more Booth encoded multipliers and output a sum of the one or more Booth compensation bits as a compensation value. Booth compensation storage 520 can be added to store the sum. The sum stored in Booth compensation storage 520 can be sent to accumulation circuitry to be applied in the accumulation of Booth partial products and/or products generated after the Booth partial products are combined.

In some cases, Booth encoder 302 outputs one or more Booth encoded multipliers correspond to a Booth group and outputs one or more further Booth encoded multipliers corresponding to a further Booth group. Booth compensation circuitry 504 can receive the one or more Booth compensation bits from the one or more Booth encoded multipliers and one or more further Booth compensation bits from the one or more further Booth encoded multipliers and output a weighted sum as a compensation value. The weighted sum is a weighted sum of the one or more Booth compensation bits corresponding to the Booth group and the one or more further Booth compensation bits corresponding to the further Booth group. The one or more Booth compensation bits are weighted by a position of the Booth group. The one or more further Booth compensation bits are weighted by a further position of the further Booth group. The weights can be powers of two based on the Booth group position. Booth compensation storage 520 can be added to store the weighted sum. The weighted sum stored in Booth compensation storage 520 can be sent to accumulation circuitry to be applied in accumulation of products generated after the Booth partial products are combined.

Referring to FIG. 5 specifically, Booth compensation circuitry 504 can be added to pre-calculate the compensation value for the stationary inputs. Booth compensation storage 520 may be added so that the compensation value can be accumulated or applied along with the accumulation or adding of Booth partial products, e.g., in weight memory 516, or the accumulation or adding of products generated after the Booth partial products are combined, e.g., in weight memory 516.

Referring to FIG. 6 specifically, Booth compensation circuitry 504 can be added to pre-calculate the compensation value for the stationary inputs. Booth compensation storage 520 may be added so that the compensation value can be propagated to systolic array 630, either from the top side or the left side. As depicted, the compensation value is propagated to systolic array 630 on the left side. Systolic array 630 can apply the compensation value as the PEs are computing partial sums of Booth partial products or the accumulation or adding of products generated after the Booth partial products are combined.

Referring to FIG. 7 specifically, Booth compensation circuitry 504 can be added to pre-calculate the compensation value for the stationary inputs. Booth compensation storage 520 may be added to, e.g., weight memory 516, so that the compensation value can be accumulated along with or applied to the accumulation or adding of Booth partial products produced by compute 716. In some cases, the compensation value can be accumulated along with or applied to the accumulation or adding of products generated after the Booth partial products are combined.

For the same reasons that Booth compensation circuitry 504 can be time-shared and amortized over the compute columns or compute tiles, Booth compensation circuitry 504 can be time-shared and amortized over the compute columns or compute tiles as well. Moreover, Booth compensation circuitry 504 can be implemented at the periphery where the stationary inputs are being loaded onto the integrated circuit.

FIG. 8 illustrates Booth compensation circuitry 504, according to some embodiments of the disclosure. In some embodiments, Booth compensation circuitry 504includes one or more tree adders 802. A tree adder instance in one or more tree adders 802 can sum one or more Booth compensation bits from the one or more Booth encoded multipliers corresponding to a Booth group across a plurality of channels and output a sum of the one or more Booth compensation bits as a compensation value. The tree adder instance can add a plurality of Booth compensation bits corresponding to a plurality of Booth encoded multipliers or sets of Booth encoded select signals across the channels and generate a summed Booth compensation output ΣS as the compensation value. The summed Booth compensation output ΣS can be sent to a Booth compensation storage. An implementation of the tree adder instance to add the Booth compensation bits across 128 channels is depicted in FIG. 8. The tree adder instance can receive the Booth compensation bit S for all the channels, e.g., 128 S-bits shown as S₀, . . . . S₁₂₇, and produce a summed Booth compensation output S.

In some embodiments, one or more tree adders 802 includes a plurality of tree adders for producing sums of the Booth compensation bits for multiple Booth groups. Each tree adder sums one or more Booth compensation bits from the one or more Booth encoded multipliers corresponding to a Booth group across a plurality of channels and outputs a sum for the Booth group as a compensation value. As a result, one or more tree adders 802 can output respective sums of the Booth compensation bits for the multiple Booth groups. Respective sums of the Booth compensation bits for the multiple Booth groups can be sent to corresponding instances of Booth compensation storage.

Booth compensation circuitry 504 further includes weigh according to group position 804. The individual sums of the Booth compensation bits for the multiple Booth groups can contribute differently depending on the Booth group position. To account for the Booth group position and its contribution, the sums are multiplied by a respective weight corresponding to the Booth group position. The weighing effectively aligns the summed Booth compensation bits according to the Booth group position.

Booth compensation circuitry 504 further includes sum 806 to add or sum the sums of Booth compensation bits weighted according to Booth group positions to produce a compensation value that can be applied to the accumulation or adding of products generated after the Booth partial products are combined.

### Reconfigurable Booth Encoder

FIG. 10 shows an implementation of reconfigurable Booth encoder 302. In particular, FIG. 10 illustrates one 8b weight input and corresponding Booth encoder 302 that can be reconfigured into enabling two 4b weights compute. In some implementations, the individual partial products generated by Booth encoded weights can be shifted and added to generate one 8b or two 4b weights-based multiplication results. This Booth encoding technique can be expanded to enable variable bit width reconfigurable weight computes, e.g., 16b, 8b, 4b, 2b, etc.

Booth encoder 302 includes a plurality of Booth group encoding circuits to receive a plurality of corresponding Booth groups of (three) multiplier bits of a multiplier to be Booth encoded. Phrased differently, every Booth group of (three) multiplier bits are processed by a corresponding Booth group encoding circuit to produce a Booth encoded multiplier or a set of Booth encoded select signals. To make Booth encoder 302 reconfigurable, two-to-one (2:1) multiplexer 1002 can be added. Two-to-one multiplexer 1002 can select a zero (0) bit or multiplier bit 1080 as an input bit to Booth group encoding circuit 1090. Two-to-one multiplexer 1002 can receive a selection signal M, which can be based on a bit width of the multiplier to be Booth encoded. When Booth encoder 302 is operating to Booth encode two 4b weights, the selection signal M can cause multiplexer 1002 to select the zero bit to be an input bit to Booth group encoding circuit 1090. Each 4b weight is Booth encoded into a 6b Booth encoded weight. When Booth encoder 302 is operating to Booth encode one 8b weight, the selection signal M can cause multiplexer 1002 to select multiplier bit 1080 (of the 8b weight) to be used as an input bit to Booth group encoding circuit 1090. In this scenario, multiplier bit 1080 is used as an input bit to Booth group encoding circuit 1090 and Booth group encoding circuit 1092. The 8b weight is Booth encoded into a 12b Booth encoded weight. Reconfigurability avoids having to implement distinct Booth encoders for different multiplier bit widths.

### Exemplary Implementations on DCIM Architecture

FIG. 11 illustrates the architecture of exemplary DCiM implementation 1100 as part of a DNN accelerator or NPU. NPU refers to a hardware accelerator that is designed to perform operations in a neural network in an efficient and optimized manner. Booth encoding is done on changing or switching activation inputs. DCiM implementation 1100 can support 8b signed/unsigned activations/weights with zero-point quantization. Zero-point quantization subtracts a fixed constant (e.g., shift in origin) from actual weights and activations (illustrated in FIG. 13), and converts them to a signed 9b value.

As an example, DCiM implementation 1100 seen in FIG. 11 has 128×9b input multiplier channels (input activations) with 32 sets of 128×9b multiplicands (weights). DCiM array 1104 can have 32 CiM columns storing 32 sets of 128×9b multiplicands to produce 32 outputs. The compute circuitry in DCiM array 1104 may implement and perform 128×32=4,096 multiplications and 32 summations of 128 element-wise multiplication products.

In some cases, DCiM array 1104 may process the input multipliers in subgroups, and provide eight sub-DCiM arrays, where a sub-DCiM array has 32 CiM columns storing 32 sets of 16 multiplicands. An example of the sub-DCiM array is shown as sub-DCiM array 1106. The eight outputs of the sub-DCiM arrays can be combined or summed as part of the dot product or MAC operation through the summing circuitry 1108. Breaking down channels of input multipliers into subgroups can simplify the adder circuits to sum the Booth partial products by operating on fewer Booth partial products at a time. Also, one or more sub-DCiM arrays can be powered down if it is not needed (e.g., if there are fewer than 128 input multipliers to be processed).

Each column of DCiM array 1104 can have two sets of 128×9b multiplicands (e.g., weights). One of these two sets can be selected to feed the Booth selector circuitry. One weight set is written by 128×9b input data “din” when write enable “wen” =1, taking 32 cycles to finish writing weights in 32 compute columns.

DCiM implementation 1100 seen in FIG. 11 includes shared input circuitry 1188, which can include Booth encoder 1120 to perform Booth encoding for the activations “act” and propagates the Booth encoded activations to all the columns of DCiM array 1104. Activations are sent through input “act”, which takes 128×9b data per cycle. Activations inputs are first Booth encoded before feeding to input flip-flops. An 8×13b Booth compensation value “sadd” is generated and sent to all the compute columns. Since, during compute, activation changes every cycle, the Booth encoder consumes power every cycle.

Shared input circuitry 1188 further includes Booth compensation 1110 to perform Booth compensation operations as illustrated in FIG. 8.

Shared input circuitry 1188 further includes write address decoder 1180. One multiplicand set, e.g., 128×9b input data “din”, is written when write enable “wen” =1. Write address wraddr[4:0] produced by write address decoder 1180 can select one of the 32 columns, while most significant bit (MSB), e.g., wradr[5] selects one of the multiplicand set in a column to be written.

DCiM implementation 1100 illustrated in FIG. 11 can be pipelined using flip-flops inserted at appropriate locations in the data processing pipeline to synchronize data that may be generated by logic circuits and arriving at different times. The flip-flops help to support the desired operating frequency and to reduce glitch power. Multipliers (e.g., input activations) are sent through input “act” to shared Booth encoder 1120, which takes 128×9b data per cycle. Multipliers inputs are first Booth encoded by Booth encoder 1120 before feeding to input flip-flops 1130 (labeled “FF”) to reduce glitch power. One or more other flip-flops, e.g., FF 1132 and FF 1134, are provided in the data processing pipeline to reduce glitch power as well.

FIG. 12 illustrates the architecture of exemplary DCiM implementation 1200 as part of a DNN accelerator or NPU. Booth encoding is done on stationary inputs such as stationary weights. As an example, DCiM implementation 1200 seen in FIG. 12 has 128×9b input multiplicand channels (activations) with 32 sets of 128×9b multipliers (weights). DCiM array 1204 can have 32 CiM columns storing 32 sets of 128×14b stationary Booth encoded multipliers to produce 32 outputs. The compute circuitry in DCiM array 1204 may implement and perform 128×32=4,096 multiplications and 32 summations of 128 element-wise multiplication products.

In some cases, DCiM array 1204 may process the input multiplicands in subgroups, and provide eight sub-DCiM arrays, where a sub-DCIM array has 32 CiM columns storing 32 sets of 16×14b stationary Booth encoded multipliers. An example of the sub-DCIM array is shown as sub-DCiM array 1206. The eight outputs of the sub-DCiM arrays can be combined or summed as part of the dot product or MAC operation through the summing circuitry 1208. Breaking down channels of input multipliers into subgroups can simplify the adder circuits to sum the Booth partial products by operating on fewer Booth partial products at a time. Also, one or more sub-DCiM arrays can be powered down if it is not needed (e.g., if there are fewer than 128 input multiplicands or input channels to be processed).

DCiM implementation 1200 seen in FIG. 12 includes shared input circuitry 1288, which can include Booth encoder 1220 to perform Booth encoding for the stationary weights “din” and propagates the Booth encoded weights to different columns of DCiM array 1204. The 128×9b stationary weights, shown as “din”, are converted into 128×14b Booth encoded weights or Booth encoded select signals (“bsel”) by Booth encoder 1220. The 128×14b Booth select signals (“bsel”) are written into the Booth weight storage or weight memory during weight writes. Each column of DCiM array 1204 can store two sets of 128×14b Booth encoded multipliers (e.g., two sets of stationary Booth encoded weights). One of these two sets can be selected to feed the Booth selector circuitry. One Booth encoded weight set 128×14b “bsel” is written to weight memory when write enable “wen” =1, taking 32 write cycles to finish writing Booth encoded weights in 32 compute columns. Since (only) one weight set is written per write cycle, the Booth encoder hardware, e.g., Booth encoder 1220, can be time-shared across multiple weight sets writes (e.g., 32 writes).

Shared input circuitry 1288 further includes Booth compensation 1210 to perform operations illustrated with Booth compensation circuitry 504 of FIG. 8. Booth compensation 1210 can use the 128×14b Booth select signals (“bsel”) to extract Booth compensation bits across the channels to produce the 8×13b Booth compensation value (“sadd”). Booth compensation value (e.g., one 13b Booth compensation value “sadd” for each sub-DCiM array) can be computed based on stationary, Booth encoded weights. The Booth compensation value can be stored in Booth compensation storage 1268 of sub-DCiM array 1206 to add to the accumulation of products.

Each column of DCIM array 1204 (or column of sub-DCiM array 1206) can have two 1×13b Booth compensation values. One of these two Booth compensation values can be selected to feed the accumulation circuitry. One Booth compensation value 1×13b “bsel” is written to Booth compensation storage 1268 when write enable “wen” =1, taking 32 cycles to finish writing Booth compensation values in 32 compute columns. Since (only) one Booth compensation value is written per write cycle, the Booth compensation hardware, e.g., Booth compensation 1210, can be shared across multiple Booth compensation writes (e.g., 32 writes).

Activations are sent through input “act”, which takes 128×9b data per compute cycle. The activation input directly goes to the Booth selector while one of the two Booth encoded weight sets is selected to feed the Booth selector.

Shared input circuitry 1288 further includes write address decoder 1280. One Booth encoded multiplier set is written by 128×14b input data “din” when write enable “wen”=1. Write address decoder 1280 can also facilitate writing of the 8×13b Booth compensation “sadd” to Booth compensation storage 1268 of the columns. Write address wraddr [4:0] produced by write address decoder 1280 can select one of the 32 columns, while MSB wradr [5] selects one of the Booth encoded multiplier set in a column to be written.

DCiM implementation 1200 illustrated in FIG. 12 is optimally pipelined using flip-flops inserted at appropriate locations in the data processing pipeline to synchronize data that may be generated by logic circuits and arriving at different times. The flip-flops help to support the desired operating frequency and to reduce glitch power. Multiplicands (e.g., input activations) are sent through input “act” to DCiM array 1204, which takes 128×9b data per cycle. Multiplier inputs are first Booth encoded by Booth encoder 1220 before feeding to input flip-flops 1230 (labeled “FF”) to reduce glitch power. One or more other flip-flops, e.g., FF 1232 and FF 1234, are provided in the data processing pipeline to reduce glitch power as well.

Compared to DCiM implementation 1100, Booth encoder 1220 of DCiM implementation 1200 generates and writes the Booth encoded weights once followed by many cycles of compute, Booth encoder 1220 consumes power (only) once during weight writes and do not consume any power during compute. In addition, Booth compensation 1210 of DCIM implementation 1200 generates and writes the Booth compensation value once followed by many cycles of compute, Booth compensation 1210 consumes power (only) once during compensation value writes and do not consume any power during compute. Moreover, (only) 128×9b activation inputs are switching, instead of having 128×14b Booth encoded activations and 8×13b Booth compensation “sadd” switching (e.g., as in the design illustrated in FIG. 11 where Booth encoding was done on activation inputs), thus further saving power.

### Integrating DCIM in a Hardware Accelerator

FIG. 14 depicts the integration of DCIM 1408 with an overall NPU architecture 1400. NPU architecture 1400 can include a MAC processing array (shown as MPA) 1410 and DCIM 1408. The improved DCIM 1408 can sit in parallel to MPA 1410, which can be gated off when DCiM 1408 is operating. NPU architecture 1400 includes static random access memory (SRAM) 1402 to store one or more input activations and one or more weights of a neural network. 1402 can be local to DCIM 1408 and MPA 1410.

MPA 1410 can include an output stationary dataflow based DNN hardware accelerator with local register files for storing activations and weights as well as the output feature maps. Output feature maps can be stored in output stationary storage 1414. MPA 1410 can form the core of the some NPU architectures.

MPA 1410 is retained as part of NPU architecture 1400 for executing floating point convolution/MatMul layers of a neural network as well as executing some special layers such as element-wise, depth-wise, max pool, and layer norm operations of the neural network. The improved DCiM 1408 can be used to execute integer-based convolution/MatMul layers of the neural network.

Input load unit 1404, post processing unit 1416, and output drain unit 1418 previously provided for MPA 1410 can be reused for DCiM 1408. Shared input logic 1406 can be implemented to perform loading and/or processing of data to DCiM 1408. Shared input logic 1406 can include a Booth encoder as described herein. Shared input logic 1406 can include Booth compensation circuitry as described herein. Shared input logic 1406 can include write address decoder as described herein. Input load unit 1404 and/or shared input logic 1406 (e.g., illustrated as shared input circuitry 1288 of FIG. 12) can be implemented to load the one or more Booth encoded weights stored into the CiM column and the further CiM column, and load the one or more input activations to DCiM 1408.

In the NPU architecture 1400, input load unit 1404 loads the weights and activations from the local SRAM 1402. Input load unit 1404 can feed the weights to shared input logic 1406 where shared input logic 1406 can apply Booth encoding to the weights. Shared input logic 1406 then feeds the Booth encoded weights to DCiM 1408, and input load unit 1404 can feed the activations to DCiM 1408. DCIM 1408 can perform the dot product or MAC operations based on the Booth encoded weights and the activations to compute the output of the convolution/MatMul operation of a neural network.

In some implementations In the NPU architecture 1400, shared input logic 1406 calculates the compensation value, and feeds the compensation value to DCIM 1408, DCIM 1408 can perform the dot product or MAC operations based on the Booth encoded weights, the activations, and the compensation value to compute the output of the convolution/MatMul operation of a neural network.

Post processing unit 1416 can apply an activation function to outputs of DCiM 1408. Examples of activation functions used in neural networks include Rectified Linear Unit (ReLU), Sigmoid, Hyperbolic Tangent (Tanh), Gaussian Error Linear Unit (GELU), and Exponential Linear Unit (ELU), etc. Post processing unit 1416 can perform re-quantization, if applicable.

Output drain unit 1418 can write an output of post processing unit 1416 to SRAM 1402.

Since DCiM 1408 is operating as a weight stationary DNN processing engine, input load unit 1404 and/or shared input logic 1406 can writes all the Booth encoded weights into DCiM 1408 columns which are kept stationary for the maximum possible hardware (or IX, IY) grid that can be loaded based on output stationary storage 1412 (e.g., the local output feature register file (“OF RF”) storage).

Output stationary storage 1412 can be included to store outputs produced by DCIM 1408. Output stationary storage 1412 includes storages, e.g., register files, to store outputs of the computed outputs of columns of DCiM 1408. Intermediate partial sums (as well as final output feature maps) that are accumulated over a subset of the total integrated circuits. Method for accelerating MAC operations in a neural network (NN) hardware accelerator

FIG. 15 is a flow diagram illustrating method 1500 for accelerating multiply-and-accumulate operations of a neural network, according to some embodiments of the disclosure. Method 1500 can be implemented or carried out by circuits illustrated in FIGS. 5-10 and 12.

In 1502, one or more multipliers are read from a memory.

In 1504, one or more Booth encoded multipliers are generated based on the one or more multipliers.

In 1506, the one or more Booth encoded multipliers are written in a Booth encoded multiplier storage.

In 1508, a plurality of compute cycles are executed. A compute cycle of the plurality of compute cycles comprises producing one or more products using the one or more Booth encoded multipliers in the Booth encoded multiplier storage and one or more multiplicands. The one or more Booth encoded multipliers are the same over the plurality of compute cycles, and the one or more multiplicands change over the plurality of compute cycles.

In 1510, in some embodiments, the one or more products produced for the compute cycle are added or summed together to perform an accumulation operation.

In some embodiments, the one or more multipliers are one or more weights of the neural network, and the one or more multiplicands are activations of a neural network. In alternative embodiments, the one or more multipliers are one or more activations of the neural network, and the one or more multiplicands are weights of a neural network. In

In some embodiments, one or more Booth compensation bits are received from the one or more Booth encoded multipliers, the one or more Booth compensation bits are summed or added to generate a sum, and the sum is written to a Booth compensation storage.

In some embodiments, the one or more Booth encoded multipliers from 1504 correspond to a Booth group. Method 1500 further includes generating one or more further Booth encoded multipliers corresponding to a further Booth group. Method 1500 further includes receiving the one or more Booth compensation bits from the one or more Booth encoded multipliers and one or more further Booth compensation bits from the one or more further Booth encoded multipliers, computing a weighted sum of the one or more Booth compensation bits and the one or more further Booth compensation bits weighted by a position of the Booth group and a further position of the further Booth group, and writing the weighted sum to a Booth compensation storage.

In some embodiments, in 1506, writing the one or more Booth encoded multipliers in the Booth encoded multiplier storage is performed during a write cycle, and the method further comprises writing one or more further Booth encoded multipliers in a further Booth encoded multiplier storage during a further write cycle. Method 1500 can further include executing a plurality of further compute cycles. A further compute cycle of the plurality of further compute cycles comprises producing one or more further products using the one or more further Booth encoded multipliers in the further Booth encoded multiplier storage and one or more further multiplicands. The one or more further Booth encoded multipliers are the same over the plurality of compute cycles, and the one or more further multiplicands change over the plurality of compute cycles.

In some embodiments, method 1500 further includes receiving, by a plurality of Booth group encoding circuits, a plurality of Booth groups of multiplier bits of a multiplier to be Booth encoded, and selecting a zero bit or a multiplier bit of a Booth group of multiplier bits as an input bit to a Booth group encoding circuit of the plurality of Booth group encoding circuits.

Exemplary computing device

FIG. 16 is a block diagram of an apparatus or a system, e.g., an exemplary computing device 1600, according to some embodiments of the disclosure. One or more computing devices 1600 may be used to implement the functionalities described with the FIGS. and herein. A number of components are illustrated in the FIGS. can be included in the computing device 1600, but any one or more of these components may be omitted or duplicated, as suitable for the application. In some embodiments, some or all of the components included in the computing device 1600 may be attached to one or more motherboards. In some embodiments, some or all of these components are fabricated onto a single System-on-Chip die. Additionally, in various embodiments, the computing device 1600 may not include one or more of the components illustrated in FIG. 16, and the computing device 1600 may include interface circuitry for coupling to the one or more components. For example, the computing device 1600 may not include a display device 1606, and may include display device interface circuitry (e.g., a connector and driver circuitry) to which a display device 1606 may be coupled. In another set of examples, the computing device 1600 may not include an audio input device 1618 or an audio output device 1608 and may include audio input or output device interface circuitry (e.g., connectors and supporting circuitry) to which an audio input device 1618 or audio output device 1608 may be coupled.

The computing device 1600 may include a processing device 1602 (e.g., one or more processing devices, one or more of the same types of processing device, one or more of different types of processing device). The processing device 1602 may include electronic circuitry that process electronic data from data storage elements (e.g., registers, memory, resistors, capacitors, quantum bit cells) to transform that electronic data into other electronic data that may be stored in registers and/or memory. Examples of processing device 1602 may include a CPU, a GPU, a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a FPGA, a TPU, a data processing unit (DPU), etc.

In some embodiments, the computing device 1600 may include NN hardware accelerator 1688 as described herein. NN hardware accelerator 1688 can interface with processing device 1602 to accelerate inference operations of neural networks. Exemplary implementations of NN hardware accelerator 1688 are illustrated in FIGS. 5-10 and 12.

The computing device 1600 may include a memory 1604, which may itself include one or more memory devices such as volatile memory (e.g., DRAM), nonvolatile memory (e.g., ROM), HBM, flash memory, solid state memory, and/or a hard drive. Memory 1604 includes one or more non-transitory computer-readable storage media. In some embodiments, memory 1604 may include memory that shares a die with the processing device 1602.

In some embodiments, memory 1604 includes one or more non-transitory computer-readable media storing instructions executable to perform operations described with the FIGS. and herein. Memory 1604 may store instructions that generate inputs to NN hardware accelerator 1688. Memory 1604 may store instructions that process outputs from NN hardware accelerator 1688. The instructions stored in the one or more non-transitory computer-readable media may be executed by processing device 1602.

In some embodiments, memory 1604 may store data, e.g., data structures, binary data, bits, metadata, files, blobs, etc., as described with the FIGS. and herein. Data may include inputs and/or outputs to NN hardware accelerator 1688 (e.g., input tensors, output tensors, input activations, output feature maps, weights of weight matrices, parameters of operations, etc.).

In some embodiments, the computing device 1600 may include a communication device 1612 (e.g., one or more communication devices). For example, the communication device 1612 may be configured for managing wired and/or wireless communications for the transfer of data to and from the computing device 1600. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1612 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1612 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. The communication device 1612 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1612 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1612 may operate in accordance with other wireless protocols in other embodiments. The computing device 1600 may include an antenna 1622 to facilitate wireless communications and/or to receive other wireless communications (such as radio frequency transmissions). The computing device 1600 may include receiver circuits and/or transmitter circuits. In some embodiments, the communication device 1612 may manage wired communications, such as electrical, optical, or any other suitable communication protocols (e.g., the Ethernet). As noted above, the communication device 1612 may include multiple communication chips. For instance, a first communication device 1612 may be dedicated to shorter-range wireless communications such as Wi-Fi or Bluetooth, and a second communication device 1612 may be dedicated to longer-range wireless communications such as global positioning system (GPS), EDGE, GPRS, CDMA, WiMAX, LTE, EV-DO, or others. In some embodiments, a first communication device 1612 may be dedicated to wireless communications, and a second communication device 1612 may be dedicated to wired communications.

The computing device 1600 may include power source/power circuitry 1614. The power source/power circuitry 1614 may include one or more energy storage devices (e.g., batteries or capacitors) and/or circuitry for coupling components of the computing device 1600 to an energy source separate from the computing device 1600 (e.g., DC power, AC power, etc.).

The computing device 1600 may include a display device 1606 (or corresponding interface circuitry, as discussed above). The display device 1606 may include any visual indicators, such as a heads-up display, a computer monitor, a projector, a touchscreen display, a liquid crystal display (LCD), a light-emitting diode display, or a flat panel display, for example.

The computing device 1600 may include an audio output device 1608 (or corresponding interface circuitry, as discussed above). The audio output device 1608 may include any device that generates an audible indicator, such as speakers, headsets, or earbuds, for example.

The computing device 1600 may include an audio input device 1618 (or corresponding interface circuitry, as discussed above). The audio input device 1618 may include any device that generates a signal representative of a sound, such as microphones, microphone arrays, or digital instruments (e.g., instruments having a musical instrument digital interface (MIDI) output).

The computing device 1600 may include a GPS device 1616 (or corresponding interface circuitry, as discussed above). The GPS device 1616 may be in communication with a satellite-based system and may receive a location of the computing device 1600, as known in the art.

The computing device 1600 may include a sensor 1630 (or one or more sensors). The computing device 1600 may include corresponding interface circuitry, as discussed above). Sensor 1630 may sense physical phenomenon and translate the physical phenomenon into electrical signals that can be processed by, e.g., processing device 1602. Examples of sensor 1630 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1600 may include another output device 1610 (or corresponding interface circuitry, as discussed above). Examples of the other output device 1610 may include an audio codec, a video codec, a printer, a wired or wireless transmitter for providing information to other devices, haptic output device, gas output device, vibrational output device, lighting output device, home automation controller, or an additional storage device.

The computing device 1600 may include another input device 1620 (or corresponding interface circuitry, as discussed above). Examples of the other input device 1620 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1600 may have any desired form factor, such as a handheld or mobile computer system (e.g., a cell phone, a smart phone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1600 may be any other electronic device that processes data.

Select examples

An integrated circuit for DNN acceleration implements energy-efficient pre-encoded Booth multiplication and exploits stationary dataflow characteristics. Booth encoders positioned at the accelerator boundary pre-encode stationary weight inputs during loading phases, storing encoded weights in memory rather than performing encoding during computation cycles. This approach eliminates Booth encoding power consumption during multiply-accumulate operations while sharing encoder hardware across multiple computation columns. The system supports reconfigurable bit-width operations (e.g., 16b/8b/4b/2b) and can be integrated with SIMD arrays, systolic arrays, or compute-in-memory architectures. The circuit comprises shared Booth encoders, Booth-encoded weight storage elements, multiplying circuits that operate without compute-time Booth encoding overhead, and precomputed compensation values.

Example 1 provides an integrated circuit for accelerating multiply-and-accumulate operations of a neural network, including a Booth encoder to receive one or more multipliers and output one or more Booth encoded multipliers based on the one or more multipliers; a Booth encoded multiplier storage to store the one or more Booth encoded multipliers; one or more multiplying circuits to execute a plurality of compute cycles, where: a compute cycle of the plurality of compute cycles includes the one or more multiplying circuits multiplying the one or more Booth encoded multipliers and one or more multiplicands and outputting one or more products; the one or more multipliers are stationary for the plurality of compute cycles; and the one or more multiplicands are switching for the plurality of compute cycles; and an adder to add the one or more products generated by the one or more multiplying circuits.

Example 2 provides the integrated circuit of example 1, where the one or more multipliers are one or more weights of the neural network, and the one or more multiplicands are one or more activations of the neural network.

Example 3 provides the integrated circuit of example 1 or 2, further including a Booth compensation circuit to receive one or more Booth compensation bits from the one or more Booth encoded multipliers and output a sum of the one or more Booth compensation bits; and a Booth compensation storage to store the sum.

Example 4 provides the integrated circuit of any one of examples 1-3, where: the one or more Booth encoded multipliers correspond to a Booth group; the Booth encoder further outputs one or more further Booth encoded multipliers corresponding to a further Booth group; a Booth compensation circuit to receive one or more Booth compensation bits from the one or more Booth encoded multipliers and one or more further Booth compensation bits from the one or more further Booth encoded multipliers, and output a weighted sum of the one or more Booth compensation bits and the one or more further Booth compensation bits weighted by a position of the Booth group and a further position of the further Booth group; and a Booth compensation storage to store the weighted sum.

Example 5 provides the integrated circuit of any one of examples 1-4, where: the Booth encoder is located in a periphery of the integrated circuit where the one or more multipliers are loaded onto the integrated circuit from a memory external to the integrated circuit.

Example 6 provides the integrated circuit of any one of examples 1-5, where: the Booth encoder outputs the one or more Booth encoded multipliers during a write cycle; and the Booth encoder outputs one or more further Booth encoded multipliers during a further write cycle.

Example 7 provides the integrated circuit of example 6, further including one or more further multiplying circuits to execute a plurality of further compute cycles, where: a further compute cycle of the plurality of further compute cycles includes the one or more further multiplying circuits multiplying the one or more further Booth encoded multipliers and one or more further multiplicands and outputting one or more further products; the one or more further Booth encoded multipliers are stationary for the plurality of further compute cycles; and the one or more further multiplicands are switching for the plurality of further compute cycles.

Example 8 provides the integrated circuit of any one of examples 1-7, where the Booth encoder includes a plurality of Booth group encoding circuits to receive a plurality of corresponding Booth groups of multiplier bits of a multiplier to be Booth encoded; and a two-to-one multiplexer that selects a zero bit or a multiplier bit as an input bit to a Booth group encoding circuit of the plurality of Booth group encoding circuits.

Example 9 provides the integrated circuit of example 8, where the two-to-one multiplexer receives a selection signal that is based on a bit width of the multiplier.

Example 10 provides the integrated circuit of any one of examples 1-9, where the one or more multiplying circuits are a part of a single-instruction-multiple-data array.

Example 11 provides the integrated circuit of any one of examples 1-9, where the one or more multiplying circuits are a part of a systolic array.

Example 12 provides the integrated circuit of any one of examples 1-9, where the one or more multiplying circuits are a part of a compute-in-memory array.

Example 13 provides an apparatus, including a memory to store activations and weights of a neural network; and a multiply-and-accumulate hardware accelerator coupled to the memory, the multiply-and-accumulate hardware accelerator including a Booth encoder to receive one or more multipliers from the memory and output one or more Booth encoded multipliers; a Booth encoded multiplier storage to store the one or more Booth encoded multipliers; and one or more multiplying circuits to execute a plurality of compute cycles based on the one or more Booth encoded multipliers and one or more multiplicands, where the one or more multipliers are stationary for the plurality of compute cycles, and the one or more multiplicands are switching for the plurality of compute cycles.

Example 14 provides the apparatus of example 13, where the multiply-and-accumulate hardware accelerator further includes an adder to add one or more products produced by the one or more multiplying circuits during a compute cycle of the plurality of compute cycles.

Example 15 provides the apparatus of example 13 or 14, where the one or more multipliers are one or more weights of the neural network, and the one or more multiplicands are one or more activations of the neural network.

Example 16 provides the apparatus of any one of examples 13-15, where the multiply-and-accumulate hardware accelerator further includes a Booth compensation circuit to receive one or more Booth compensation bits from the one or more Booth encoded multipliers and output a sum of the one or more Booth compensation bits; and a Booth compensation storage to store the sum.

Example 17 provides the apparatus of any one of examples 13-16, where the multiply-and-accumulate hardware accelerator further includes the one or more Booth encoded multipliers correspond to a Booth group; the Booth encoder further outputs one or more further Booth encoded multipliers corresponding to a further Booth group; a Booth compensation circuit to receive one or more Booth compensation bits from the one or more Booth encoded multipliers and one or more further Booth compensation bits from the one or more further Booth encoded multipliers, and output a weighted sum of the one or more Booth compensation bits and the one or more further Booth compensation bits weighted by a position of the Booth group and a further position of the further Booth group; and a Booth compensation storage to store the weighted sum.

Example 18 provides the apparatus of any one of examples 13-17, where: the Booth encoder is located in a periphery of the multiply-and-accumulate hardware accelerator where the one or more multipliers are loaded onto the multiply-and-accumulate hardware accelerator from the memory.

Example 19 provides the apparatus of any one of examples 13-17, where: the Booth encoder outputs the one or more Booth encoded multipliers during a write cycle; the Booth encoder outputs one or more further Booth encoded multipliers during a further write cycle.

Example 20 provides the apparatus of example 19, where the multiply-and-accumulate hardware accelerator further includes one or more further multiplying circuits to execute a plurality of further compute cycles based on the one or more further Booth encoded multipliers and one or more further multiplicands, where the one or more further Booth encoded multipliers are stationary for the plurality of further compute cycles, and the one or more further multiplicands are switching for the plurality of further compute cycles.

Example 21 provides the apparatus of any one of examples 13-20, where the Booth encoder includes a plurality of Booth group encoding circuits to receive a plurality of corresponding Booth groups of multiplier bits of a multiplier to be Booth encoded; and a two-to-one multiplexer that selects a zero bit or a multiplier bit as an input bit to a Booth group encoding circuit of the plurality of Booth group encoding circuits.

Example 22 provides the apparatus of example 21, where the two-to-one multiplexer receives a selection signal that is based on a bit width of the multiplier.

Example 23 provides the apparatus of any one of examples 13-22, where the one or more multiplying circuits are a part of a single-instruction-multiple-data array.

Example 24 provides the apparatus of any one of examples 13-22, where the one or more multiplying circuits are a part of a systolic array.

Example 25 provides the apparatus of any one of examples 13-22, where the one or more multiplying circuits are a part of a compute-in-memory array.

Example 26 provides a method for accelerating multiply-and-accumulate operations of a neural network, including reading one or more multipliers from a memory; generating one or more Booth encoded multipliers based on the one or more multipliers; writing the one or more Booth encoded multipliers in a Booth encoded multiplier storage; and executing a plurality of compute cycles, where a compute cycle of the plurality of compute cycles includes producing one or more products using the one or more Booth encoded multipliers in the Booth encoded multiplier storage and one or more multiplicands; where: the one or more Booth encoded multipliers are the same over the plurality of compute cycles; and the one or more multiplicands change over the plurality of compute cycles.

Example 27 provides the method of example 26, further including adding the one or more products produced for the compute cycle.

Example 28 provides the method of example 26 or 27, where the one or more multipliers are one or more weights of the neural network, and the one or more multiplicands are one or more activations of the neural network.

Example 29 provides the method of any one of examples 26-28, further including receiving one or more Booth compensation bits from the one or more Booth encoded multipliers; summing the one or more Booth compensation bits to generate a sum; and writing the sum to a Booth compensation storage.

Example 30 provides the method of any one of examples 26-29, where: the one or more Booth encoded multipliers correspond to a Booth group; the method further includes generating one or more further Booth encoded multipliers corresponding to a further Booth group; receiving one or more Booth compensation bits from the one or more Booth encoded multipliers and one or more further Booth compensation bits from the one or more further Booth encoded multipliers; computing a weighted sum of the one or more Booth compensation bits and the one or more further Booth compensation bits weighted by a position of the Booth group and a further position of the further Booth group; and writing the weighted sum to a Booth compensation storage.

Example 31 provides the method of any one of examples 26-30, where writing the one or more Booth encoded multipliers in the Booth encoded multiplier storage is performed during a write cycle, and the method further includes writing one or more further Booth encoded multipliers in a further Booth encoded multiplier storage during a further write cycle.

Example 32 provides the method of example 31, further including executing a plurality of further compute cycles, where a further compute cycle of the plurality of further compute cycles includes producing one or more further products using the one or more further Booth encoded multipliers in the further Booth encoded multiplier storage and one or more further multiplicands; where: the one or more further Booth encoded multipliers are the same over the plurality of compute cycles; and the one or more further multiplicands change over the plurality of compute cycles.

Example 33 provides the method of any one of examples 26-32, further including receiving, by a plurality of Booth group encoding circuits, a plurality of Booth groups of multiplier bits of a multiplier to be Booth encoded; and selecting a zero bit or a multiplier bit of a Booth group of multiplier bits as an input bit to a Booth group encoding circuit of the plurality of Booth group encoding circuits.

Example 34 provides an apparatus including means for performing a method according to any one of examples 26-33.

### Variations and other notes

Although the operations of the example method shown in and described with reference to FIGS. are illustrated as occurring once each and in a particular order, it will be recognized that the operations may be performed in any suitable order and repeated as desired. Additionally, one or more operations may be performed in parallel. Furthermore, the operations illustrated in FIGS. may be combined or may include more or fewer details than described.

The various implementations described herein may refer to artificial intelligence, machine learning, and deep learning. Deep learning may be a subset of machine learning. Machine learning may be a subset of artificial intelligence. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed:

1. An integrated circuit for accelerating multiply-and-accumulate operations of a neural network, comprising:
a Booth encoder to receive one or more multipliers and output one or more Booth encoded multipliers based on the one or more multipliers;
a Booth encoded multiplier storage to store the one or more Booth encoded multipliers;
one or more multiplying circuits to execute a plurality of compute cycles, wherein:
a compute cycle of the plurality of compute cycles includes the one or more multiplying circuits multiplying the one or more Booth encoded multipliers and one or more multiplicands and outputting one or more products;
the one or more multipliers are stationary for the plurality of compute cycles; and
the one or more multiplicands are switching for the plurality of compute cycles; and
an adder to add the one or more products generated by the one or more multiplying circuits.

2. The integrated circuit of claim 1, wherein the one or more multipliers are one or more weights of the neural network, and the one or more multiplicands are one or more activations of the neural network.

3. The integrated circuit of claim 1, further comprising:
a Booth compensation circuit to receive one or more Booth compensation bits from the one or more Booth encoded multipliers and output a sum of the one or more Booth compensation bits; and
a Booth compensation storage to store the sum.

4. The integrated circuit of claim 1, wherein:
the one or more Booth encoded multipliers correspond to a Booth group;
the Booth encoder further outputs one or more further Booth encoded multipliers corresponding to a further Booth group;
a Booth compensation circuit to receive one or more Booth compensation bits from the one or more Booth encoded multipliers and one or more further Booth compensation bits from the one or more further Booth encoded multipliers, and output a weighted sum of the one or more Booth compensation bits and the one or more further Booth compensation bits weighted by a position of the Booth group and a further position of the further Booth group; and
a Booth compensation storage to store the weighted sum.

5. The integrated circuit of claim 1, wherein:
the Booth encoder is located in a periphery of the integrated circuit where the one or more multipliers are loaded onto the integrated circuit from a memory external to the integrated circuit.

6. The integrated circuit of claim 1, wherein:
the Booth encoder outputs the one or more Booth encoded multipliers during a write cycle; and
the Booth encoder outputs one or more further Booth encoded multipliers during a further write cycle.

7. The integrated circuit of claim 6, further comprising:
one or more further multiplying circuits to execute a plurality of further compute cycles, wherein:
a further compute cycle of the plurality of further compute cycles includes the one or more further multiplying circuits multiplying the one or more further Booth encoded multipliers and one or more further multiplicands and outputting one or more further products;
the one or more further Booth encoded multipliers are stationary for the plurality of further compute cycles; and
the one or more further multiplicands are switching for the plurality of further compute cycles.

8. The integrated circuit of claim 1, wherein the Booth encoder includes:
a plurality of Booth group encoding circuits to receive a plurality of corresponding Booth groups of multiplier bits of a multiplier to be Booth encoded; and
a two-to-one multiplexer that selects a zero bit or a multiplier bit as an input bit to a Booth group encoding circuit of the plurality of Booth group encoding circuits.

9. The integrated circuit of claim 8, wherein the two-to-one multiplexer receives a selection signal that is based on a bit width of the multiplier.

10. The integrated circuit of claim 1, wherein the one or more multiplying circuits are a part of a single-instruction-multiple-data array.

11. The integrated circuit of claim 1, wherein the one or more multiplying circuits are a part of a systolic array.

12. The integrated circuit of claim 1, wherein the one or more multiplying circuits are a part of a compute-in-memory array.

13. An apparatus, comprising:
a memory to store activations and weights of a neural network; and
a multiply-and-accumulate hardware accelerator coupled to the memory, the multiply-and-accumulate hardware accelerator comprising:
a Booth encoder to receive one or more multipliers from the memory and output one or more Booth encoded multipliers;
a Booth encoded multiplier storage to store the one or more Booth encoded multipliers; and
one or more multiplying circuits to execute a plurality of compute cycles based on the one or more Booth encoded multipliers and one or more multiplicands, wherein the one or more multipliers are stationary for the plurality of compute cycles, and the one or more multiplicands are switching for the plurality of compute cycles.

14. The apparatus of claim 13, wherein the multiply-and-accumulate hardware accelerator further comprises an adder to add one or more products produced by the one or more multiplying circuits during a compute cycle of the plurality of compute cycles.

15. The apparatus of claim 13, wherein the one or more multipliers are one or more weights of the neural network, and the one or more multiplicands are one or more activations of the neural network.

16. The apparatus of claim 13, wherein the multiply-and-accumulate hardware accelerator further includes:
a Booth compensation circuit to receive one or more Booth compensation bits from the one or more Booth encoded multipliers and output a sum of the one or more Booth compensation bits; and
a Booth compensation storage to store the sum.

17. A method for accelerating multiply-and-accumulate operations of a neural network, comprising:
reading one or more multipliers from a memory;
generating one or more Booth encoded multipliers based on the one or more multipliers;
writing the one or more Booth encoded multipliers in a Booth encoded multiplier storage; and
executing a plurality of compute cycles, wherein a compute cycle of the plurality of compute cycles comprises producing one or more products using the one or more Booth encoded multipliers in the Booth encoded multiplier storage and one or more multiplicands;
wherein:
the one or more Booth encoded multipliers are the same over the plurality of compute cycles; and
the one or more multiplicands change over the plurality of compute cycles.

18. The method of claim 17, further comprising:
adding the one or more products produced for the compute cycle.

19. The method of claim 17, wherein the one or more multipliers are one or more weights of the neural network, and the one or more multiplicands are one or more activations of the neural network.

20. The method of claim 17, further comprising:
receiving one or more Booth compensation bits from the one or more Booth encoded multipliers;
summing the one or more Booth compensation bits to generate a sum; and
writing the sum to a Booth compensation storage.
